(19) United States
(12) Patent Application Publication
(10) Pub. No.: US 2005/0011497 A1
(43) Pub. Date: Jan. 20, 2005

(54) Fuel supply system for an internal combustion engine

(75) Inventor: Anders Larsson, Lerum (SE)

Correspondence Address: TRACY W. DRUCE, ESQ.;NANCY DRUCE LLP, 1615 L STREET NW, SUITE 850, WASHINGTON, DC, 20036, US

(73) Assignee: Volvo Lastvagnar AB, Goteborg (SE)

(21) Appl. No.: 10/709,983

(22) Filed: Jun. 10, 2004

Related U.S. Application Data
(63) Continuation of application No. PCT/SE02/02074, filed on Nov. 14, 2002.

(30) Foreign Application Priority Data
Dec. 11, 2001 (SE) 0104197-9

(51) Int. Cl. F02M 1/00

(52) U.S. Cl. 123/516

(57) ABSTRACT

Arrangement for a fuel system for an internal combustion engine (10) that includes a fuel tank (13), a fuel pump (12) and a fuel filter (19) located in a flow duct (14, 23) between the fuel pump and the fuel consumers (11) of the engine. The flow duct (14, 23) is provided with a non-return valve (25) and a bleed valve (26-29) arranged downstream thereof in the normal flow direction of the fuel system.

### TECHNICAL FIELD

The present invention relates to an arrangement for a fuel system for an internal combustion engine, comprising a fuel tank, a fuel pump and a fuel filter located in a flow duct between the fuel pump and the fuel consumers of the engine.

### BACKGROUND ART

Fuel systems for internal combustion engines are usually designed in such a way that exchanging a fuel filter involves emptying the fuel line between the outlet of the filter housing and the cylinder head. In this connection, the fuel, which is an environmentally harmful substance, should be collected to avoid spillage. Exchanging a fuel filter is a common service action, especially on heavy diesel engines which are used a great deal.

It is usual for fuel systems for diesel engines to be provided with a bleed nipple and a hand pump which can be used when air bleeding and refilling of fuel is carried out. Before the engine is started, a large number of strokes of the hand pump are required, and it is necessary to open one or more bleed nipples in order to remove the quantity of air present in the new filter. This involves expensive workshop time and also a risk of fuel spillage because the nipples are generally not closed before fuel flows therefrom.

There are fuel systems with devices for automating the procedure for removing air (see, for example, U.S. Pat. No. 5,534,161). This patent describes a pump which can be driven in two directions by means of a microprocessor and can be used for removing water from a fuel system. This device, however, can only facilitate the procedure for bleeding air from the fuel system, and further actions are required in order to remove air from the high-pressure side of the system. This device therefore requires that the number of components in the fuel system be increased, while still not fully solving the problem of facilitating the procedure for bleeding.

### DISCLOSURE OF INVENTION

One object of the invention is therefore to produce a fuel system which makes possible automated removal of air after filter exchange without the system being complicated or expensive.

The presently disclosed arrangement which is designed for this purpose comprises (includes, but is not limited to) a fuel tank, a fuel pump and a fuel filter located in a flow duct between the fuel pump and the fuel consumers of the engine. According to the invention, the flow duct is provided with a non-return valve and a bleed valve arranged downstream therefrom in the normal flow direction of the fuel system. On the one hand, this design of the fuel system ensures that fuel spillage during filter exchange is minimized, and, on the other hand, the subsequent bleeding of the fuel system can take place automatically.

In one illustrative embodiment of the invention, the flow duct extends in the upward direction between the non-return valve and the bleed valve.

In another illustrative embodiment of the invention, the bleed valve comprises a bleed port which is connected to the fuel tank.

In a further illustrative embodiment of the invention, the fuel filter is mounted on a filter holder with internal ducts for conducting fuel to and from the filter. The filter holder is suitably located at a certain distance from the fuel consumers of the engine.

The filter holder suitably forms a mounting for a prefilter which is located close to the fuel filter and can also be connected to the fuel tank via a suction line which extends on to the fuel pump.

A second bleed valve is suitably located in the fuel system between the consumers of the engine and the fuel pump. This second valve is suitably mounted at a point which is normally located high up in the fuel system.

### BRIEF DESCRIPTION OF THE DRAWINGS

The invention will be described in greater detail below with reference to illustrative embodiments shown in the accompanying drawings, and in which:

FIG. 1 is diagrammatic illustration of an internal combustion engine with a fuel system configured according to the teachings of the present invention; and

FIG. 2 provides a detailed view, on an enlarged scale of the filter holder as depicted in the fuel system of FIG. 1, including associated filters.

### MODE FOR THE INVENTION

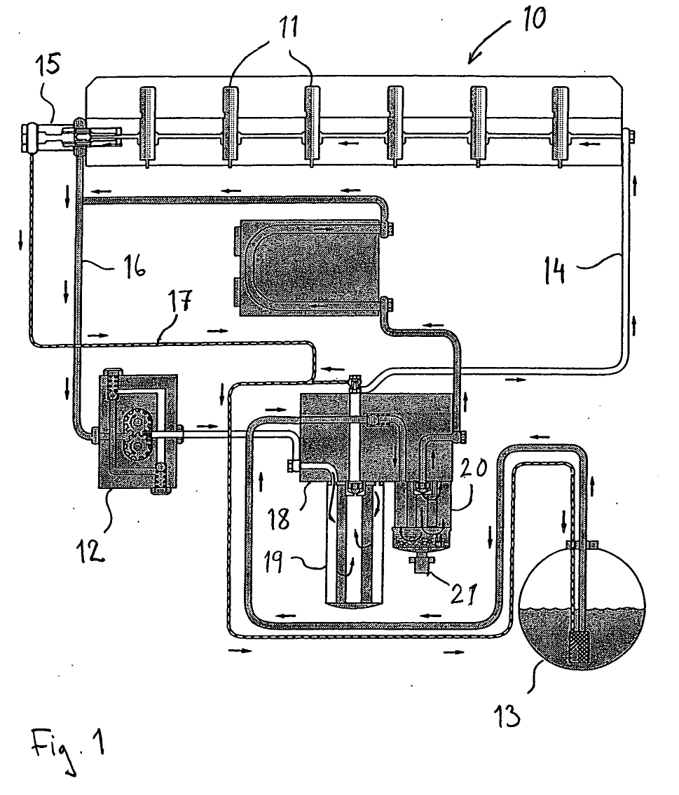

The internal combustion engine 10 shown diagrammatically in FIG. 1 is exemplarily a six-cylinder diesel engine with a corresponding number of injectors 11 of standard type. This engine can be used in order, for example, to drive a heavy truck.

A pump 12 driven by the engine of the vehicle feeds diesel fuel from a tank 13, via a common feeder line 14, to the injectors 11. A combination valve 15 for pressure control and bleeding is mounted downstream of the injectors 11, with the connection line from the injectors directed upward, in such a way that the valve is located vertically above this inlet. A return line 16 for uncombusted fuel is connected to the combination valve at a point above the connection line from the injectors. A bleed line 17 is also connected to the combination valve at a point above the return line 16, which bleed line communicates with the fuel tank 13.

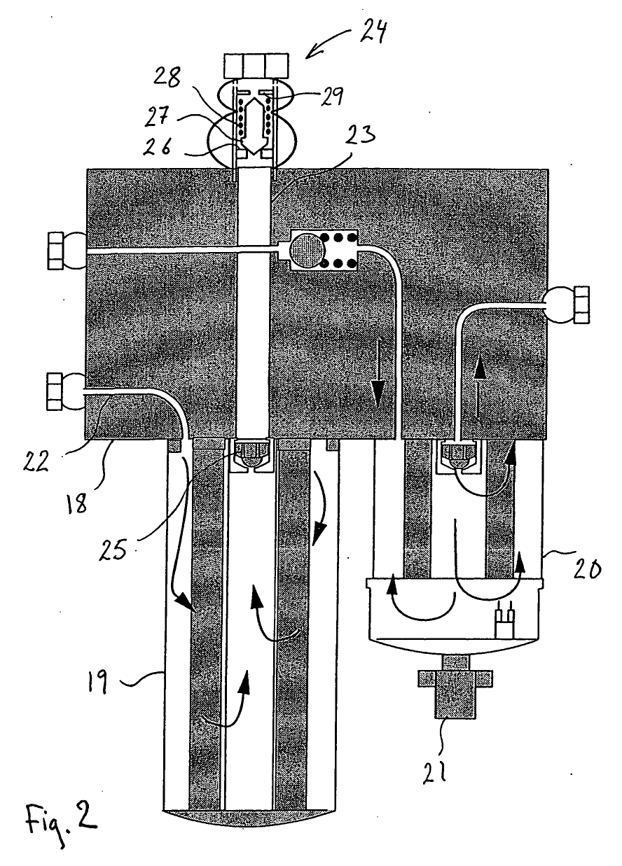

The fuel system also comprises a filter holder 18 with a main fuel filter 19 and a prefilter/water separator 20 with a drain valve 21. The filter holder is shown in greater detail in FIG. 2 and is provided with internal ducts which connect the respective filter to the fuel system. One duct 22 connects the inlet side of the main filter 19 to the fuel pump 12. Another duct 23 connects the outlet side of the main filter to a pipe connection 24, which duct 23 is provided with a non-return valve 25 which is arranged so as to close in the direction toward the filter 19. The non-return valve 25 is freely movable in order to prevent the fuel line 14 being emptied when a used filter 19 is disconnected.

The pipe connection 24 comprises a bleed valve with a lower seat 26 and a valve cone 27 that is arranged to act against this seat under the influence of a spring means 28. The bleed valve is designed in such a way that it allows air to pass through relatively rapidly but, when the fuel arrives, the valve closes completely, which occurs when the valve cone interacts with an upper seat 29. The pipe connection 24 comprises a lower pipe coupling to the pipeline 14 and an upper pipe coupling which is connected to the bleed line 17.

The inlet side of the prefilter 20 is connected to the suction line of the tank, while its outlet side communicates with the return line 16 to the fuel pump 12.

When the engine is started after the fuel filter 19 has been changed, the fuel pump 12 sucks (vacuums) fuel from the tank 13 and fills the filter 19. When the pressure in the filter has become sufficiently great, the non-return valve is lifted, and the air passes onward via the duct 23 to the bleed valve of the pipe connection 24 and on to the bleed line 17. When the fuel reaches the bleed valve, it is closed, and the fuel starts being pushed to the consumers 11 of the engine via the pipeline 14.

As the non-return valve 25 has low mass in combination with a large seat surface, and the cone of the bleed valve 27 works counter to a spring means, a slight positive pressure is rapidly formed in the fuel filter.

This positive pressure is transmitted to the line and constitutes a prerequisite for the engine starting and continuing to run for the time it takes before all the air has passed out through the bleed valve, and the pressure can rise to the normal level which is maintained by the combination valve 15. The engine therefore runs even during the bleeding process because fuel still remains around the injectors 11 and in the fuel line 14 leading thereto. It should be pointed out that this assumes that the engine is running under low load; that is to say, with low fuel consumption. This makes it possible for the pump to replace the air quantity present in the filter with fuel. Small quantities of air which might perhaps pass through the bleed valve 27 are dealt with by the combination valve 15 for return to the tank 13.

The invention is not to be regarded as being limited to the illustrative embodiments described above, but a number of further variants and modifications are conceivable within the scope of the patented claims.

1. An arrangement for a fuel system to an internal combustion engine, said arrangement comprising:
a fuel tank (13), a fuel pump (12) and a fuel filter (19) located in a flow duct (14, 23) between the fuel pump and the fuel consumers (11) of the engine; and
said flow duct (14, 23) being provided with a non-return valve (25) and a bleed valve (26-29) arranged downstream thereof in the normal flow direction of the fuel system.

2. The arrangement as recited in claim 1, wherein said flow duct (23) extends in an upward direction between said non-return valve (25) and said bleed valve (26-29).

3. The arrangement as recited in claim 1, wherein said bleed valve (26-29) further comprises a bleed port connected to said fuel tank (13).

4. The arrangement as recited in claim 1, wherein said fuel filter (19) is mounted on a filter holder (18) with internal ducts (22, 23) for conducting fuel to and from said filter (19).

5. The arrangement as recited in claim 4, wherein said filter holder (18) is located at a certain distance from the fuel consumers (11) of the engine.

6. The arrangement as recited in claim 4, wherein said filter holder (18) forms a mounting for a prefilter (20) proximate said fuel filter (19).

7. The arrangement as recited in claim 6, wherein said prefilter (20) is connected to said fuel tank (13) via a suction line (16) that extends from said prefilter (20) to said fuel pump (12).

8. The arrangement as recited in claim 1, further comprising:
a second bleed valve (15) located in said fuel system between the consumers (11) of the engine and said fuel pump (12).

9. The arrangement as recited in claim 8, wherein said second bleed valve (15) is positioned elevationally high up in the fuel system.

10. The arrangement as recited in claim 1, wherein said arrangement is configured to permit automatic air purge of a newly installed fuel filter (19) and minimize spillage of fuel into the environment during air purge of the newly installed fuel filter (19).
